(19) United States
(12) Patent Application Publication
(10) Pub. No.: US 2005/0045211 A1
(43) Pub. Date: Mar. 3, 2005

(54) Method for cleaning and/or disinfecting the vaccum channels of a sealing station

(76) Inventor: Herman Schmidt, Bad Laasphe (DE)

Correspondence Address: PERMAN & GREEN, 425 POST ROAD, FAIRFIELD, CT, 06824, US

(21) Appl. No.: 10/495,542

(22) PCT Filed: Oct. 17, 2002
(86) PCT No.: PCT/EP02/11608

(30) Foreign Application Priority Data
Nov. 14, 2001 (DE) 101 55 757.4

(51) Int. Cl. B08B 9/00; B65B 31/00

(52) U.S. Cl. 134/22.1; 134/22.11; 53/167; 53/432; 53/510

(57) ABSTRACT

The invention relates to a method, whereby a cleaning and disinfecting circuit is established for the vacuum channels of an upper sealing tool (1) and a lower sealing tool (2). In the present case, the vacuum pump (3) is switched off and the connecting line to the sealing station is sealed or disconnected from the flanges at the point (10). The vacuum channels of the upper sealing station (1) are connected to the vacuum channels of the lower sealing tool (2) by means of an adapter (13) in a fluid-tight manner. The fluid circuit is closed by a pump (14), a fluid container (15) and the associated pipes, which are connected to the flanges (11), (12). Said pump (14) pumps a cleaning and disinfecting fluid, in the present case active chlorine, into the vacuum channels of the upper sealing station (1).

The present invention relates to a method for cleaning and/or disinfecting the vacuum channels of a sealing station in which the vacuum channels are separated from the pump and connected to a cleaning and/or disinfecting circuit at regular intervals.

The invention also relates to a cleaning and/or disinfecting circuit, a cleaning adapter and a packaging machine.

Nowadays, increasingly high demands are made on the hygiene of packaging machines, in particular in the foodstuffs field. Consequently, it is necessary to ensure that all parts of the packaging machine which come into direct or indirect contact with the packaged items are cleaned and disinfected at regular intervals. This also applies to the vacuum channels in the sealing station which are used to draw the air out of the packaging and, for example, replace it with inert gas. When the air is drawn out, frequently small particles of food are drawn along with it and these are deposited in the vacuum channels and, in particular during the downtime of the packaging machine, encourage germ formation in these vacuum channels.

Therefore, it was the object of this invention to provide a method for cleaning and/or disinfecting the vacuum channels.

The object is achieved by a method for cleaning and/or disinfecting the vacuum channels of a sealing station whereby the vacuum channels are separated from the pump at regular intervals and connected to a cleaning and/or disinfecting circuit.

It was extremely surprising and unexpected to a person skilled in the art that the method according to the invention enables the production of foodstuffs with far fewer germs and hence a longer shelf life than was possible with machines according to the prior art. The method according to the invention is simple and inexpensive to perform, for example following the daily operation of the machine before its downtime at night.

In a preferred embodiment of the invention, the cleaning circuit comprises a pump and a fluid reservoir. The fluid reservoir contains a cleaning and/or disinfecting fluid, for example active chlorine, which is pumped by the pump through the vacuum channels and runs out of the vacuum channels back into the fluid reservoir. This circuit is maintained until it is ensured that the vacuum channels have been sufficiently cleaned and/or disinfected.

A sealing station generally comprises first and second sealing tools which interact in such a way that a covering film seals a packaging tray. Hereby, a first sealing tool is arranged above the covering film and a second sealing tool below the packaging tray. The second sealing tool is generally vertically adjustable.

In a preferred embodiment of the invention, the first and the second sealing tools are connected independently of each other to a cleaning and/or disinfecting circuit. This embodiment has the advantage that the vacuum channels in the first, upper sealing tool, in which food remnants are frequently deposited, may be cleaned more frequently than the vacuum channels in the second, lower sealing tool.

In another preferred embodiment of the method according to the invention, the sealing station comprises first and second sealing tools which are connected to a cleaning and/or disinfecting circuit and connected to each other by an adapter. The adapter creates a fluid-tight connection between the vacuum channels of the first and second sealing tools so that a fluid circuit can rinse both sealing tools in sequence with the cleaning and/or disinfecting fluid. This embodiment of the method according to the invention is particularly simple to perform and requires only a slight modification of the packaging machine.

The cleaning and/or disinfecting fluid used may be any cleaning and/or disinfecting fluid known to a person skilled in the art capable of cleaning and optionally disinfecting the channels. However, preferably active chlorine is used as the cleaning and/or disinfecting fluid.

Preferably, the cleaning and/or disinfecting circuit is decoupled again following the cleaning and/or disinfection. Germ-free compressed air is then conveyed through the vacuum channels until they have dried, so that no cleaning and/or disinfecting fluid contaminates the food to be packed during the subsequent packaging process.

Another object of the invention is a cleaning and/or disinfecting circuit with a pump, a fluid reservoir and pipes, whereby the pipes may be connected to the vacuum channels in the sealing station of a packaging machine.

The circuit system has the advantage that the vacuum channels in the sealing station are simple and inexpensive to clean. The cleaning and/or disinfecting circuit is simple to attach to the packaging machine.

In a preferred embodiment, the cleaning and/or disinfecting circuit is connected to the packaging machine in a detachable way. This embodiment of the cleaning and/or disinfecting circuit according to the invention has the advantage that a cleaning and/or disinfecting circuit may be used for several packaging machines and that the cleaning and/or disinfecting circuit does not have to be located in the vicinity of the packaging machine during the actual packaging process and hence does not represent a safety and contamination risk for the foodstuffs to be packaged.

Another object of the invention is a cleaning and/or disinfecting adapter for the reversible, fluid-tight connection of the vacuum channels in first and second sealing tools in a sealing station. This cleaning and/or disinfecting adapter enables the first and second sealing tools to be connected together in such a way that both tools may be connected to a cleaning and/or disinfecting fluid circuit so that the cleaning and/or disinfection of the vacuum channels is very simple and quick to perform.

Another object of the invention is a packaging machine, in particular a deep drawing packaging machine with connections for a cleaning and/or disinfecting circuit in the vacuum channels of the sealing station.

In a preferred embodiment, the cleaning and/or disinfecting circuit may be connected in a reversible manner.

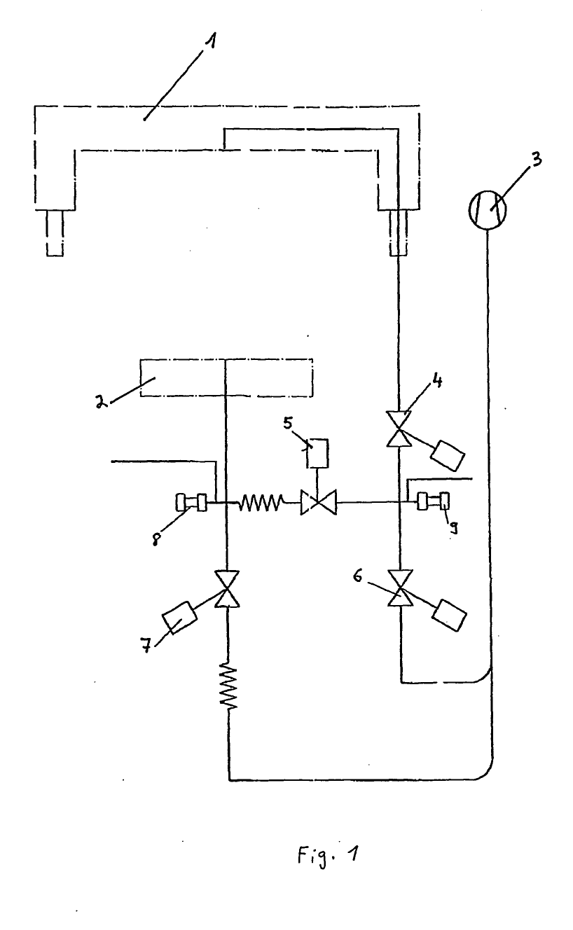

The invention will now be described with reference to FIGS. 1 to 3. These explanations are examples only and do not restrict the general concept of the invention.

FIG. 1 shows a process diagram for the generation of a vacuum in the first and second sealing tools.

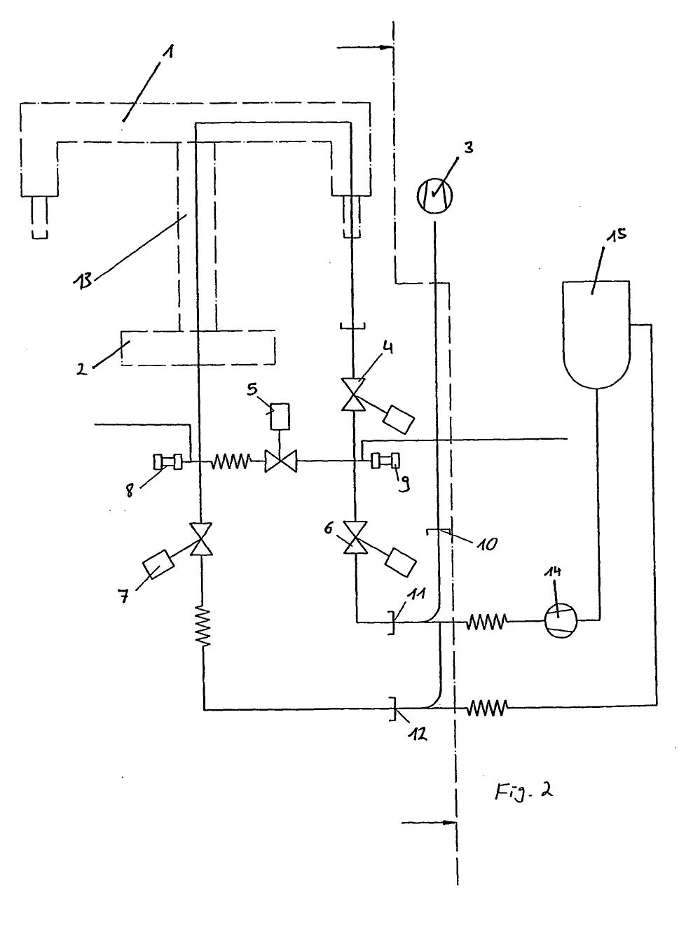

FIG. 2 shows the method according to the invention in which the first and second sealing tools are connected to a cleaning and disinfecting circuit.

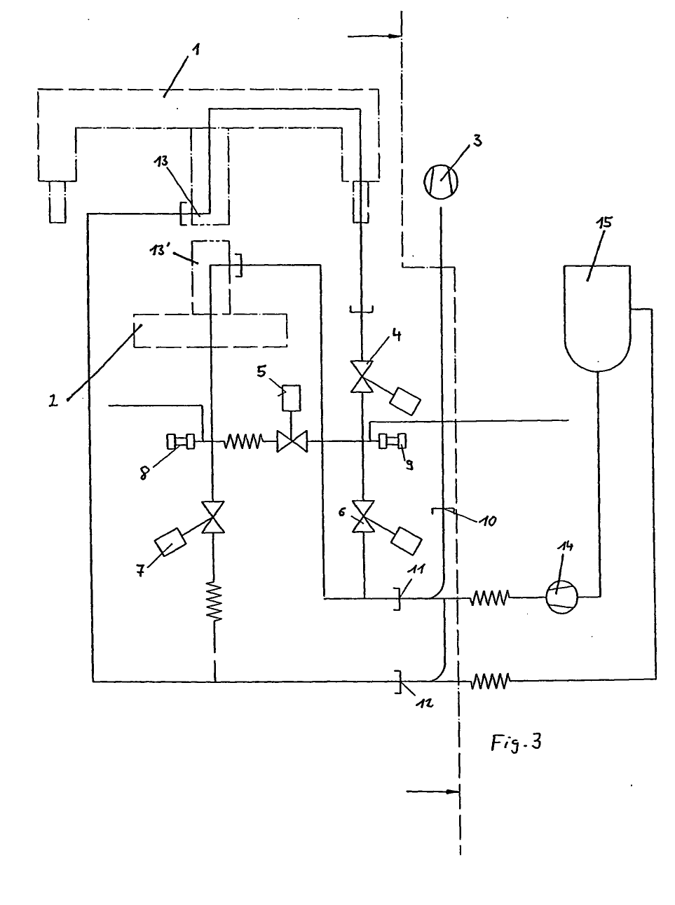

FIG. 3 shows an embodiment of the method according to the invention in which the upper and lower sealing tools are connected independently of each other to a cleaning and disinfecting circuit.

FIG. 1 shows a process diagram for the evacuation of the vacuum channels in a sealing station according to the prior art. The sealing station comprises an upper sealing tool 1 and a lower sealing tool 2. Worked into these sealing tools are channels through which the air may be drawn out of the packaging. It is drawn out via the vacuum pump 3. Valves 4 to 7 distributes underpressure generated by the vacuum pump 3 to the vacuum channels of the upper sealing tool 1 and the vacuum channels of the lower sealing tool 2 in a desired way. When the sealing is completed, the underpressure is relieved via the valves 8 and 9.

FIG. 2 shows a diagram of the method according to the invention in which a cleaning and disinfecting circuit for the vacuum channels of the upper sealing tool 1 and of the lower sealing tool 2 is installed. In this case, the vacuum pump 3 is switched off and the connecting line to the sealing station sealed or disconnected from the flanges at point 10. The vacuum channels in the upper sealing station 1 are connected to the vacuum channels of the lower sealing tool 2 by means of an adapter 13 in a fluid-tight manner. The fluid circuit is closed by a pump 14, a fluid reservoir 15 and the associated pipes which are connected to the flanges 11, 12. The pump 14 pumps a cleaning and disinfecting fluid, in this case active chlorine, into the vacuum channels of the upper sealing tool 1. From there, the fluid runs through the adapter 13 into the vacuum channels of the lower sealing tool 2 from where it is returned to the fluid reservoir 15 in order to participate in the cleaning and/or disinfecting process again. This fluid circuit is maintained until the vacuum channels are sufficiently cleaned and disinfected. For cleaning and/or disinfecting of the valve 5 and the associated pipes, the valve 4 is completely closed so that a fluid circuit is established only by the valves 5, 6 and 7. When the cleaning or disinfecting is completed, the pump 14 and the fluid reservoir 15 are disconnected from the evacuation pipes again and the vacuum pump 3 attached again. In addition, the adapter 13 is removed. Germ-free air is conveyed through the vacuum channels in the sealing tools 1, 2 until they have completely dried so that no cleaning and disinfecting fluid can contaminate the foodstuffs to be packed.

FIG. 3 shows a cleaning and disinfecting circuit for the vacuum channels of the upper sealing tool 1 and the vacuum channels of the lower sealing tool 2. Essentially, the explanations for FIG. 2 apply to this embodiment of the method according to the invention, only in this case the adapters 13, 13′ do not establish a connection between the vacuum channels of the upper sealing tool 1 and of the lower sealing tool 2. This enables the vacuum channels in the upper sealing tool to be cleaned independently of the vacuum channels in the lower sealing tool and vice versa. This embodiment of the method is in particular expedient if the vacuum channels in the upper sealing tool are more heavily contaminated than the vacuum channels in the lower sealing tool, as is frequently the case.

1. Method for cleaning and/or disinfecting the vacuum channels of a sealing station characterised in that the vacuum channels are separated from the vacuum pump (3) and connected to a cleaning and/or disinfecting circuit at regular intervals.

2. Method according to claim 1, characterised in that the cleaning and/or disinfecting circuit comprises a pump (14) and a cleaning and/or disinfecting fluid reservoir (15).

3. Method according to claim 1, characterised in that the sealing station comprises first and second sealing tools (1,2) which are each connected to a cleaning and/or disinfecting circuit.

4. Method according to claim 1, characterised in that the sealing station comprises first and second sealing tools (1,2) connected to a cleaning and/or disinfecting circuit and connected to each other by an adapter (13).

5. Method according to claim 1, characterised in that active chlorine is used as the cleaning and/or disinfecting fluid.

6. Method according to claim 1, characterised in that the cleaning and/or disinfecting circuit is decoupled after the cleaning and/or disinfection and the vacuum channels (4-9) are dried with germ-free air.

7. Cleaning and/or disinfecting circuit with a pump (14), a fluid reservoir (15) and pipes, characterised in that the pipes may be connected to the vacuum channels in the sealing station of a packaging machine.

8. Cleaning and/or disinfecting circuit according to claim 7, characterised in that the connection is detachable.

9. Cleaning and/or disinfecting adapter (13, 13′) to provide a reversible, fluid-tight connection between the vacuum channels in first and second sealing tools (1,2) of a sealing station.

10. Packaging machine, in particular a deep-drawing packaging machine with connections (11,12) for cleaning and/or disinfecting circuit.

11. Packaging machine according to claim 10, characterised in that the cleaning and/or disinfecting circuit may be connected in a reversible manner.
